(19) United States
(12) Patent Application Publication
(10) Pub. No.: US 2024/0037280 A1
(43) Pub. Date: Feb. 1, 2024

(54) Facial Recognition Filter for Restricting Access to Photographs

(71) Applicant: GeoSnapshot Pty Ltd, Mona Vale (AU)

(72) Inventor: Andrew John Edwards, Dee Why (AU)

(21) Appl. No.: 18/226,461

(22) Filed: Jul. 26, 2023

Related U.S. Application Data
(60) Provisional application No. 63/369,793, filed on Jul. 29, 2022.

(51) Int. Cl. G06F 21/62; G06V 40/16

(52) U.S. Cl. CPC G06F 21/6263; G06F 21/6254; G06V 40/172; G06F 2221/2141

(57) ABSTRACT

Biometric information, such as facial recognition technology, can be used to execute a filter to restrict access to digital photographs via a network platform such as a school website, a company portal, or a social network. A user interface screen 200 of a user device may be implemented in connection with allowing a user to control the associated filtering system. The user can use interface element 202 to provide a digital photograph of the protected person. Optionally, the interface 200 may include a further element 204 for identifying the photograph collections to which the filter should be applied. Finally, the interface 200 includes a button 206 for applying the filter. Upon application of the filter, appropriate restrictions are applied with respect to photographs from the selected collections 204 that include the protected person.

### CROSS-REFERENCE TO RELATED APPLICATION

This application claims priority to U.S. Provisional Patent Application No. 63/369,793 entitled “Facial Recognition Filter for Restricting Access to Photographs,” filed Jul. 29, 2022, the contents of which are incorporated herein as if set forth in full and priority is claimed to the full extent allowable under U.S. law and regulations.

### FIELD OF THE INVENTION

The present invention relates to restricting access to photographs via a network such as the Internet and, in particular, to a system that uses biometrics such as facial recognition to identify photographs subject to access restrictions and implement the restrictions.

### BACKGROUND OF THE INVENTION

In recent years, many people have grown concerned regarding the availability of digital photographs, e.g., of themselves and their children, over networks such as the Internet. These concerns generally relate to security and privacy considerations. The availability of digital photographs raises security concerns, for example, because the photographs can be used to facilitate identity theft or to target potential victims for other criminal activities, among other things. Privacy considerations include undesired repurposing of the digital photographs for commercial purposes or advertising or to create a false or misleading impression about a person. For these reasons, many are now careful about how their digital photographs are published and distributed.

However, web-based platforms also provide convenient access to digital photographs for a variety of useful purposes. Schools and businesses may publish collections of photographs from events or for teams, clubs, or other organizations. These can help to promote a sense of community and enable parents to more fully participate in their children's lives, among other benefits. Similarly, social networks and other platforms allow people to conveniently share events and memories with others with whom they are separated by distance or circumstance. It would therefore be useful to provide a system for enabling sharing of digital photographs over networks while respecting the desires of individuals to restrict access to or use of the digital photographs.

### SUMMARY OF THE INVENTION

The present invention is directed to a system and associated functionality for restricting access to digital photographs on a network platform. Biometric information, such as facial recognition technology, can be used to execute a filter to restrict access to digital photographs via a network platform such as a school website, a company portal, or a social network. In this manner, individuals or parents can easily restrict access to digital photographs, e.g., to prevent access or limit access with respect to certain people or purposes. It will be appreciated that enabling access to digital photographs while protecting security and privacy interests is a problem that arises in the context of accessing digital images via a computer network.

In accordance with one aspect of the present invention, a system and associated functionality (“utility”) is provided for securing access to digital photographs. The utility involves providing a platform for obtaining digital photographs from a collection of digital photographs and enabling access to the photographs via a network. For example, the platform may be associated with a school website, a company portal, or a social network, among other possibilities. In connection with the platform, a filter system is provided for accessing a first digital photograph and processing the first digital photograph to obtain first biometric information. For example, the first biometric information may comprise facial recognition information. Such facial recognition information may relate to identifying nodal points in a photograph of a person, obtaining measurements or relative geometric information relative to such nodal points such as the distance between the person's eyes, the width of the person's nose, the relative spacing or orientation of features, etc., and converting that information into a set of values. However, it will be appreciated that other information that can be obtained from a digital photograph, e.g., relating to other physical characteristics of a protected person may be utilized.

The utility further involves comparing the first biometric information to the collection of digital photographs to identify one or more matching photographs. In this regard, the matching photographs may include matching information that matches the first biometric information. Various metrics such as thresholds and confidence levels may be used to distinguish matching photographs from other photographs. Upon identifying matching photographs, access to the matching photographs may be restricted via the platform. In this regard, all network users may be prevented from accessing the matching photographs, less than all network users may be restricted from accessing the matching photographs (e.g., specific users may be white-listed or black-listed), the matching photographs may be modified in relation to the matching information, and/or allowed uses for the photograph may be defined. For example, the matching photographs may be cropped, blurred, or distorted, to limit or substantially prevent access to the sensitive information, e.g., the likeness of a protected person. In this manner, network users can conveniently access collections of digital photographs while respecting the security and privacy concerns of interested parties.

### BRIEF DESCRIPTION OF THE DRAWINGS

For a more complete understanding of the present invention, and further advantages thereof, reference is now made to the following Detailed Description, taken in conjunction with the drawings, in which:

FIG. 1 is a block diagram of a biometric filtering system in accordance with the present invention;

FIGS. 2-3 show examples of user interface screens on the biometric filtering system of FIG. 1;

FIGS. 4-7 are screenshots illustrating the results of the filtering system of FIG. 1; and

FIG. 8 is a flowchart illustrating the functionality of the filtering system of FIG. 1.

### DETAILED DESCRIPTION

The present invention relates to using biometric information to limit access to or use of digital photographs in a network. In the following description, the invention is set forth in the context of using facial recognition functionality to remove digital photographs from or modify digital photographs of a collection on a website. However, it will be appreciated that the invention is not limited to this context or functionality. Accordingly, the following description should be understood as exemplary and not by way of limitation.

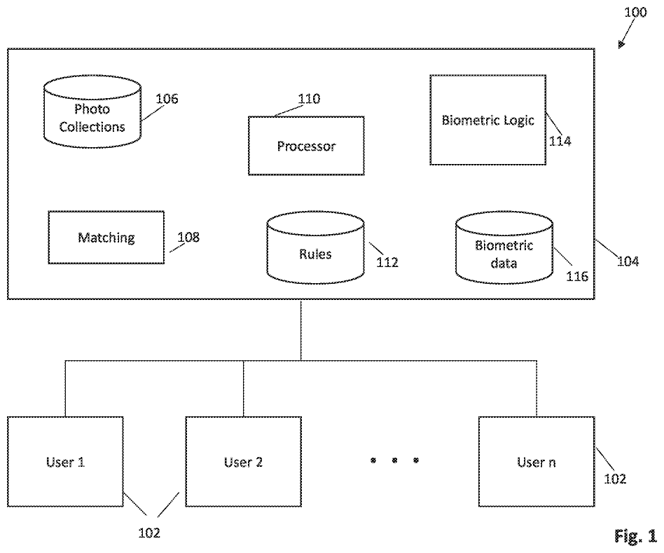

FIG. 1 illustrates a biometric filtering system 100 in accordance with the present invention. The system 100 generally includes a platform 104 that can be accessed by users 102 to limit access to or use of digital photographs, as well as to access photographs of a collection, in connection with a website. In the following discussion, certain examples will be provided relating to enabling parents to selectively allow or disallow use of their childrens' photographs on a website, e.g., a school or sports team website. It will be appreciated that the system is not limited to this context and can be implemented in a variety of other contexts where it is desired to limit access to or use of photographs of protected persons in connection with a network such as the Internet.

As will be described in more detail below, the users 102 communicate with the platform 104 to implement a variety of functions. In this regard, the users 102 may use smart phones, tablet computers, laptop computers, desktop computers, or other data terminals to access the platform 104. Although the platform 104 is illustrated as a single element, it will be appreciated that the platform 104 may be executed on one or more machines (e.g., computers or servers) at a single site or geographically distributed. Each such site may execute the full functionality of the illustrated platform 104 or the functionality may be distributed across sites. Moreover, the functionality may be distributed in various ways between the platform 104, the user devices, and any other platforms, e.g., some preprocessing of digital information may be executed at the user devices or other platforms, for example, to facilitate rapid response or reduce use of processing resources of the platform or communication bandwidth requirements. The platform 104 may be hosted by a website operator or may be implemented separately (e.g., cloud-based) and connected to the website platform via an interface such as API.

In the illustrated system 100, a user 102 such as a parent may access the platform 104, which may embody a school website, to access and selectively filter photo collections 106 that are available on or via the platform 104. For example, the photo collections may include photos for a particular classroom, for a particular event, or for a sports team or other intramural activity. For example, the parent may wish to remove digital photographs of their child from the photograph collections 106, or a particular collection of the collections 106, or may choose to limit access to or use of the child's digital photographs. Accordingly, the parent may access certain templates as will be described in more detail below to define rules that are stored in a collection 112 of rules. In a simple example, a parent may specify that no digital photographs including the child should be accessible via the platform 104. This can be implemented via a facial recognition technology. For example, the parent can upload or select a photograph of the child and indicate that digital photographs including the child should not be published on the platform 104. The platform 104 can then use facial recognition to identify matching photographs of the child and remove those photographs from the collections 106 or otherwise restrict access to the photographs. In other cases, the parent may specify limitations concerning access to or use of the photographs.

The illustrated platform 104 includes a collection of rules 112 for designated persons (“protected persons”), e.g., one or more children at a school. Some examples of rules include: remove pictures including the protected person from the photograph collection 106; where possible, crop the photographs to remove the protected person; pixelate or otherwise obscure the protected person from the photographs; limit access for matching photographs to internal use; prevent (black-list) or permit (white-list) access by particular people/groups or for particular purposes; prevent downloading/sale of photographs including the protected person; prevent use of photographs including the protected person for commercial or advertising purposes; etc. As discussed below, these rules may be defined, at least in part, based on responses to a survey, entries on a form, or other information provided in a template.

The platform 104 further includes biometric logic 114 and biometric database 116. The biometric logic 114 is operative for acquiring and structuring biometric data. Biometric data includes any data concerning an individual's persona that can be used to identify the person and, in the present application, includes characteristics that can be obtained from a digital photograph. In this regard, many physical characteristics or combinations thereof may be useful in identifying a person including: overall height, dimensions, and proportions; individual facial features such as the width of a person's nose, the size and shape of a person's eyes, mouth, ears, etc.; overall facial features such as spacing between the eyes, relative geometry of the eyes, nose, and mouth, overall width and height of a person's face, gait or other characteristics of movement apparent in videos, etc.

In one implementation, the present invention employs a facial recognition technique to identify a protected person and to match that person to images in photographs of the collections 106. Specifically, multiple facial features are noted, measured, and otherwise characterized such as width of the person's nose, spacing between person's eyes, etc. These features are then stored in the biometric database 116 as sets of values. Similar values are stored for each identified face in the photo collection 116, are associated with metadata describing the data and associated fields, and are indexed to a particular person. It will be appreciated that many facial recognition techniques have been developed, e.g., for authentication and security purposes, including advanced techniques involving artificial intelligence, and any such techniques can be employed in connection with the present invention.

To apply the rules 112, matching logic 108 may be employed to match the biometric data for a protected person to faces from the digital photograph collection 106. For example, individual values from the sets of biometric data and/or composite values for all or certain features may be compared. Matching may be determined based on threshold comparisons, value similarities, pattern matching, confidence levels for matches, or other parameters and may be algorithm-based and/or involve artificial intelligence/machine learning. The matching criteria may be similar to those applied in other contexts such as authentication and security contexts or may be relaxed or strengthened to account for uncertainties due to matching to uncontrolled and un-posed photographs where the subjects' faces may be distant, oriented at an angle that complicates facial recognition, or otherwise obscured/partially obscured. The processor 110, which may be embodied in one or more servers or computers, controls the operation of the various elements 106, 108, 112, 114, and 116.

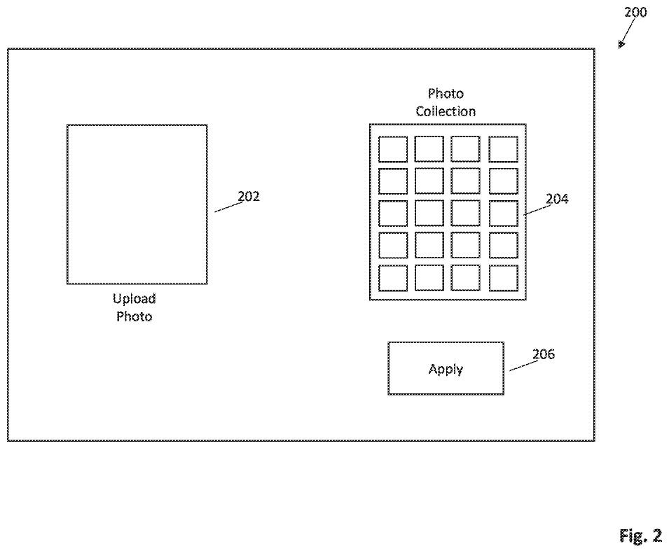

FIG. 2 illustrates a user interface screen 200 that may be implemented in connection with allowing a user to control the filtering system. The interface 200 may be provided on a user device as described above and may be presented as part of an application running on the user device or implemented via interaction between the user device and the platform. In many cases, the filtering system may simply allow a protected person, a parent, or other interested party to upload a digital photograph of the protected person such that all photographs in a collection that include the protected person can be eliminated from the collection or rendered unavailable for accessing by third parties. The screen 200 is a simple interface for executing such a filter. In particular, the user can use interface element 202 to provide a digital photograph of the protected person. For example, the photograph may be uploaded, dragged-and-dropped from a photograph collection, or the user may browse a collection of photographs to select a photograph of the protected person. Optionally, the interface 200 may include a further element 204 for identifying the photograph collections to which the filter should be applied. Finally, the interface 200 includes a button 206 for applying the filter. Upon application of the filter, appropriate restrictions are applied with respect to photographs from the selected collections 204 that include the protected person.

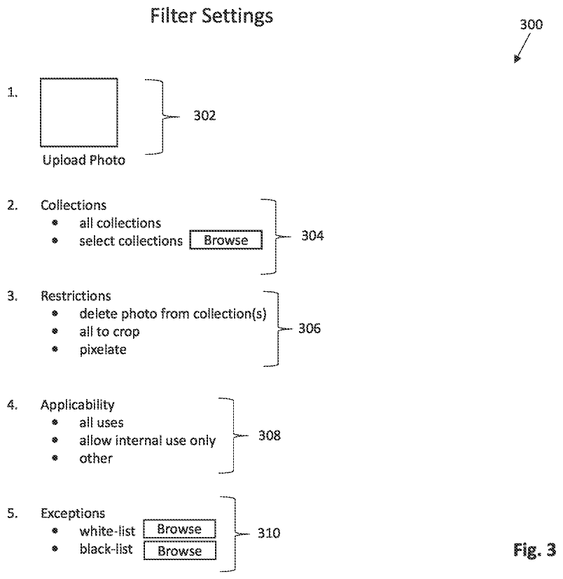

FIG. 3 shows an example of a user interface screen 300 that may be implemented to define more detailed filter settings. Although the associated functionality is illustrated as being implemented in connection with a single user interface screen 300, it will be appreciated that similar functionality may be presented in a series of screens and may be implemented via various graphical elements such as pull-down menus, browsing prompts, radio buttons, and the like. Using the illustrated interface 300, a user can provide (302) a digital photograph of the protected person, e.g., by uploading a photograph or otherwise identifying a digital photograph. The user can then select (304) the photograph collections to which the filter settings will apply. The user can also select (306) the specific restrictions that are desired. In the illustrated example, the user can select one or more of the options: delete matching digital photographs from the collection(s) (or remove the digital photographs from the collection that is displayed to any user, thereby allowing for the possibility that the protected persons/parents can change their settings and unrestrict the photo), auto-crop the protected person from matching photographs, and pixelate the protected person in the matching photographs. It will be appreciated that additional options and combinations of options may be provided. For example, the filter settings may be set to auto-crop the protected person from matching photographs when possible and to otherwise either pixelate the protected person or remove the matching photograph from the collection(s).

The illustrated interface 300 further allows the user to select (308) the applicability of the settings. The restrictions noted above may be applied with respect to all uses, may be applied for any non-internal uses, or other parameters may be used to define the applicability of the restrictions. The user may also define (310) certain exceptions or inclusions. For example, the user may white-list or black-list certain people/groups or uses for matching photographs. It will be appreciated that other filter settings may be employed in accordance with the present invention.

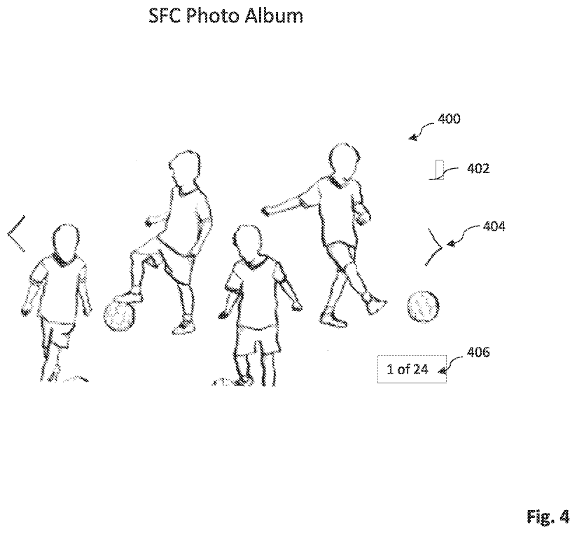

FIGS. 4-7 show various user interface screens reflecting the operation of different filter settings. In this regard, FIG. 4 shows a user interface screen 400 that displays a collection of digital photographs 402 without any filters applied. The interface screen 400 may include navigation elements 404 that allow a user to browse through a gallery of photographs. In addition, the screen 400 may include gallery information 406 that identifies what photograph is being viewed and how many photographs are in the gallery. In this case, the gallery information 406 indicates that the photograph being viewed is the first photograph of a gallery that includes 24 total photographs.

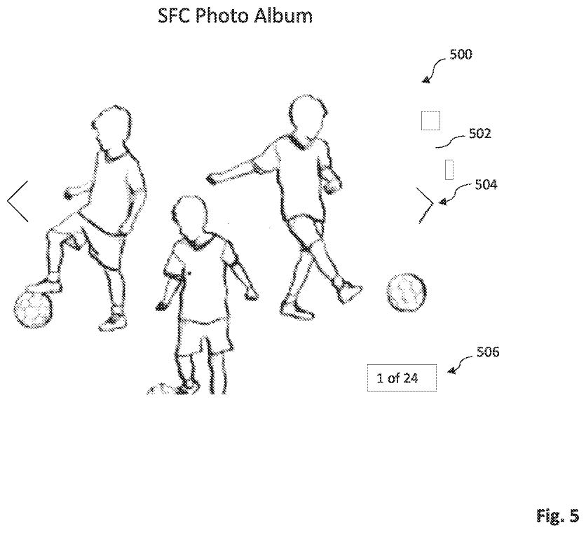

FIG. 5 shows a user interface screen 500 that may be presented for the same gallery depicted in FIG. 4 but with an auto-crop filter applied. In this case, the screen 500 still includes a display 502 of digital photographs, navigation elements 504, and gallery information 506. The gallery still includes 24 total photographs and, again, the illustrated photograph is the first photograph of the gallery. However, as shown, the photograph has now been cropped so that one of the football players, i.e., the protected person, has been eliminated from the photograph as displayed.

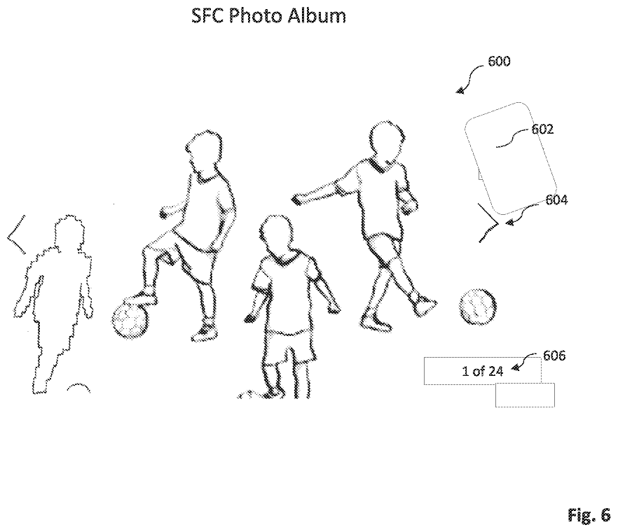

FIG. 6 shows a user interface screen 600 that may be presented for the same gallery depicted in FIG. 4 but with a pixelate filter applied. The screen 600 again includes navigation elements 604 and gallery information 606. The gallery includes 24 total photographs and the first photograph of the gallery is shown. However, in this case, the illustrated photograph has been altered so that the protected person is pixelated in the displayed image.

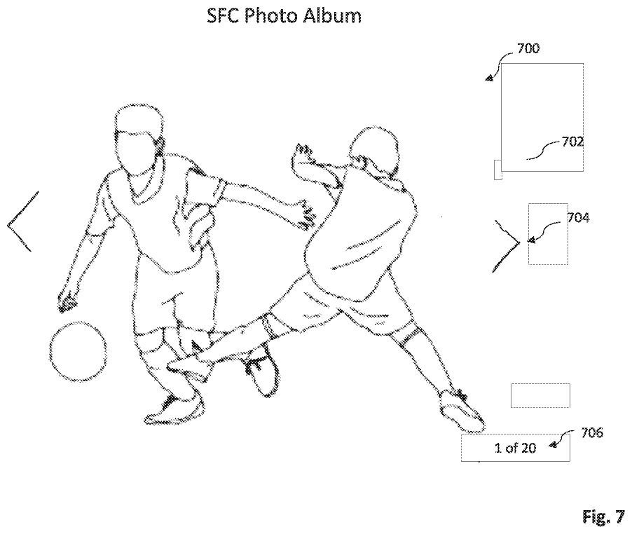

FIG. 7 shows a user interface screen 700 that may be presented for the same gallery depicted in FIG. 4 but with a photograph deletion filter applied. The screen 700 includes a display 702 of digital photographs, navigation elements 704, and gallery information 706. In this case, all photographs including the protected person have been removed from the gallery as displayed. Consequently, photograph one of the gallery is a different photograph. In addition, as shown by the gallery information 706, the gallery now includes only 20 photographs rather than 24 (indicating that four photographs deemed to include the protected person have been removed from the gallery as displayed).

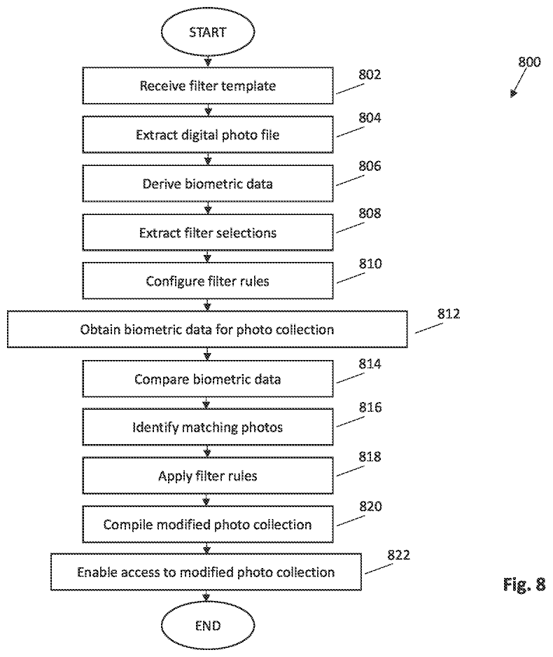

FIG. 8 is a flowchart illustrating a filtering process 800 in accordance with the present invention. For example, the process 800 may be executed by logic running on a school website platform, a separate cloud-based platform, or other platform executing the filtering functionality. The illustrated process 800 is initiated by receiving (802) a filter template. For example, the template may include a digital photograph of a protected person and filter settings as described above. The template may be received in a single input or message or a series of inputs or messages. The template may be provided as responses to survey questions, as inputs provided by populating a form, or in any other appropriate way.

The illustrated process 800 further involves extracting (804) a digital photo file for the protected person. For example, the digital photo file may be extracted from a message uploaded by the user or may be obtained from a separate collection of photographs based on information provided by the user. The system can then derive (806) biometric data from the digital photograph file. For example, biometric logic may be employed to identify various facial features and compile sets of data reflecting measurements and other geometric relationships of features, among other things. In addition, the system may extract (808) filter selections from information provided by the user. In some cases, the filters selections may simply indicate that any photographs including the protected person should be eliminated from the relevant photograph collections. In other cases, as discussed above, more complex or conditional restrictions may be applied.

Based on the filters selections, the system may configure (810) appropriate filter rules. For example, these rules may control the system to auto-crop or pixelate photographs, to monitor access requests to identify the requestor or purpose of the request, or to otherwise restrict access to or use of matching photographs. The system may also obtain (812) biometric data for the relevant photograph collection(s). In this regard, the system may preemptively, or in response to an access request, process each photograph in a collection. For example, for each photograph, the system may first identify each portion of the photograph that includes a face or portion thereof. The system can then identify facial features, obtain sets of values for the facial features, store the values in a biometric database, and compare (814) the biometric data to corresponding data for one or more protected persons. If a match is identified (816), the appropriate filter rules can be applied (818) based on the identity of the protected person for whom a match was identified.

The relevant photograph collection can then be modified or controlled as required by the applicable filter rules. For example, if a photograph elimination filter has been selected, the matching photographs may be removed from the collection as presented. In other cases, the matching photographs may be cropped or pixelated, for example. In any case, a modified photograph collection is thereby compiled (820). Finally, access to the modified photo collection is selectively enabled (822). In some cases, the matching photographs may be permanently deleted or reversibly removed from the photograph collection. In other cases, a new copy of the photograph collection may be generated and designated as available for users to access via a website. In still other cases, both the original photograph collection and the modified photograph collection may be available to be accessed by different people for different purposes as defined by the filter rules.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in securing access to digital photographs, comprising:
providing a platform for obtaining digital photographs from a collection of digital photographs and enabling access to said photographs via a network;
in connection with said platform, providing a filter system operative for:
accessing a first digital photograph;
processing said first digital image to obtain first biometric information;
comparing said first biometric information to said collection of digital photographs to identify one or more matching photographs that include matching information that matches said first biometric information; and
restricting access to said matching photographs via said platform.

2. The method of claim 1, wherein said restricting comprises preventing access to said matching photographs for all network users.

3. The method of claim 1, wherein said restricting comprises preventing access to said matching photographs for less than all network users.

4. The method of claim 1, wherein said restricting comprises preventing access to one or more first portions of said matching photographs including said matching information.

5. The method of claim 4, wherein preventing access comprises modifying said first portions.

6. The method of claim 5, wherein said modifying comprises one of cropping, blurring, or distorting said first portions.

7. The method of claim 1, wherein said processing comprises implementing a facial recognition technology.

8. The method of claim 1, wherein said first biometric information comprises reference spatial information concerning a physical feature of a protected person.

9. The method of claim 1, wherein said processing comprises extracting first feature information from said first digital photograph and deriving a first set of values based on said features.

10. The method of claim 9, wherein said comparing comprises extracting second feature information to each candidate digital photograph of said collection of digital photographs, deriving candidate sets of values for each of said candidate digital photographs, and comparing said first set of values to each of said candidate sets of values.

11. A system for use in securing access to digital photographs, comprising:
a platform for obtaining digital photographs from a collection of digital photographs and enabling access to said photographs via a network;
said platform including a filter system operative for:
accessing a first digital photograph;
processing said first digital image to obtain first biometric information;
comparing said first biometric information to said collection of digital photographs to identify one or more matching photographs that include matching information that matches said first biometric information; and
restricting access to said matching photographs via said platform.

12. The system of claim 11, wherein said restricting comprises preventing access to said matching photographs for all network users.

13. The system of claim 11, wherein said restricting comprises preventing access to said matching photographs for less than all network users.

14. The system of claim 11, wherein said restricting comprises preventing access to one or more first portions of said matching photographs including said matching information.

15. The system of claim 14, wherein preventing access comprises modifying said first portions.

16. The system of claim 15, wherein said modifying comprises one of cropping, blurring, or distorting said first portions.

17. The system of claim 11, wherein said processing comprises implementing a facial recognition technology.

18. The system of claim 11, wherein said first biometric information comprises reference spatial information concerning a physical feature of a protected person.

19. The system of claim 11, wherein said processing comprises extracting first feature information from said first digital photograph and deriving a first set of values based on said features.

20. The system of claim 19, wherein said comparing comprises extracting second feature information to each candidate digital photograph of said collection of digital photographs, deriving candidate sets of values for each of said candidate digital photographs, and comparing said first set of values to each of said candidate sets of values.
